(19) United States
(12) Patent Application Publication
(10) Pub. No.: US 2020/0118000 A1
(43) Pub. Date: Apr. 16, 2020

(54) METHOD AND SYSTEM FOR DISTRIBUTED DEEP LEARNING

(71) Applicant: NEC Laboratories Europe GmbH, Heidelberg (DE)

(72) Inventors: Mischa Schmidt, Heidelberg (DE); Andreas Ripke, Neckargemuend (DE)

(21) Appl. No.: 16/234,617

(22) Filed: Dec. 28, 2018

Related U.S. Application Data
(60) Provisional application No. 62/743,569, filed on Oct. 10, 2018.

(51) Int. Cl. G06N 3/08; G06N 3/04

(52) U.S. Cl. CPC G06N 3/084; G06N 3/04

(57) ABSTRACT

A method for synchronizing data parallel deep learning nodes includes: training, by a deep learning node of the data parallel deep learning nodes, a deep learning model, having a hierarchy of layers, using backpropagation; interleaving, by the deep learning node, layer-wise backpropagation calculations with backpropagation message communications; assigning, by the deep learning node, priority levels to the backpropagation message communications based on the hierarchy of layers; and prioritizing, by the deep learning node, transmission among the backpropagation message communications based on the priority levels. At least one of the backpropagation message communications transmits a message having information on at least one of a gradient or a weight.

### CROSS-REFERENCE TO RELATED APPLICATION

Priority is claimed to U.S. Provisional Patent Application No. 62/743,569, filed on Oct. 10, 2018, the entire disclosure of which is hereby incorporated by reference herein.

### FIELD

The present invention relates to a method and system for distributed deep learning.

### BACKGROUND

Deep learning (DL) is a class of machine learning (ML) approaches that has achieved notable success across a wide spectrum of tasks, including speech and visual recognition and language understanding. Such DL models have a high degree of model complexity, with many parameters in deeply layered structures that can take days to weeks to train on a GPU-equipped machine. The high computational cost of DL programs on large-scale data necessitates the training on distributed GPU cluster (i.e., distributed DL) in order to keep the training time acceptable. See, e.g., Hao Zhang et. al, “Poseidon: An Efficient Communication Architecture for Distributed Deep Learning on GPU Clusters,” at ArXiv 1706.03292 (2017) (hereinafter, “Zhang”) (discussing deep learning models) (the entire contents of which are hereby incorporated by reference herein).

The use of GPUs (as compared to CPUs) allows for a large number of data batches to be processed per minute, this is due to the high computational throughput of GPUs. However, the high number of batches per minute leads to a challenge when scaling DL on GPU clusters (i.e., in distributed DL), namely that there can frequent network synchronization that grows with the number of machines. State of the art communication strategies, such as parameter servers (PS) for ML, can be overwhelmed by this high volume of communication. Furthermore, despite the increasing availability of faster network interfaces (such as Infiniband or 40 GbE Ethernet), GPUs have outpaced the improvements in the network. In particular, GPUs have continued to improve their computational power and to produce parameter updates faster than can be naively synchronized over the network. For instance, on a 16-machine cluster with 40 GbE Ethernet and one Titan X GPU per machine, updates from the VGG19-22K DL model will bottleneck the network.

The inventors have recognized that these scalability limitations in distributed DL derive from at least two causes. First, these DL systems require gradient updates to be communicated as very large matrices, which quickly saturate network bandwidth. Second, DL algorithms are iterative, which causes the updates to be transmitted in bursts (at the end of an iteration or batch of data), with significant periods of low network usage in between.

DL models use a family of hierarchical models containing many layers, i.e., a neural network (NN). The number of layers in a NN of a DL model can vary greatly, from only a few (e.g., 5-10) to many hundreds. Generally, a NN has a first layer, which is an input layer that reads (or receives) input data; intermediate layer(s), which is(are) connected in sequence to the input layer and apply a function transformation; and finally, an output layer, which is connected in sequence to the intermediate layer(s) to output a prediction. At each intermediate layer, there can be several “neurons” of the NN, each of which applies a function transformation on its input to produce an output. For each layer, a vector output is obtained by concatenating the output of all the neurons in the layer, which is fed to the next layer. Because the NN has a hierarchy model of many layers, the NN can transform raw input data one layer at time, turning input data into a series of intermediate representations, and finally transforming to the output prediction.

NNs generally need to be trained with data to give accurate predictions. Training neural networks can be based on minimizing a loss function and adjusting (updating) the neural network's weights (a “loss function” is a measure of how good a prediction model does in terms of being able to predict the expected outcome). In deep learning settings, the updates need to be applied correctly across the different network layers.

For example, stochastic gradient descent (SGD) and backpropagation can be used to iteratively train NNs. Each iteration performs a feed forward (FF) pass followed with a backpropagation (BP) pass. FIG. 1 illustrates feed forward (FF) and backpropagation (BP) passing through five layers and demonstrates the order of layers from “low” (Layer 1) to “high” (Layer 5). In the FF pass, the network takes a training sample as input, forwards from its input layer to output layer to produce a prediction. A loss function is defined to evaluate the prediction error, which is then backpropagated through the network in reverse, during which the network parameters are updated by their gradients towards where the error would decrease. After repeating a sufficient number of passes, the network will usually converge to some state where the loss is close to a minima, and the training is then terminated.

A particular class of approaches to training neural networks relies on using continuous, differentiable loss functions (e.g., the mean squared error, Equation 1 (discussed below)); and continuous, differentiable network activation functions (e.g., the sigmoid function

$$\frac{1}{1 + {e}^{- x}} ) .$$

Equation 1 (mean squared error) is expressed as

$$L = \frac{1}{N} {\sum }_{i = 1}^{N} {( {t}_{i} - f ( {x}_{i} ) )}^{2} ,$$

where N is the number of samples, tᵢ is the i^{th} target value, and f(xᵢ) is the neural network prediction for input sample xᵢ. For the simple iterative gradient descent based backpropagation, the neural network updates it's layers' weights wⱼ by calculating and applying the appropriate partial error derivatives

$$\frac{\partial L}{\partial {w}_{j}}$$

(for simplicity of notation, here only a single index j is used). Using a vector notation, the layer-wise propagated gradient of L is denoted ∇L. Then, the weights of layer l are updated by the layer-wise propagated gradient: w̅ₗ̅=w̅ₗ̅−α∇Lₗ, with α being a learning rate parameter.

To speed up training in a DL model, a parallelization strategy may be used. For DL, parallelization's strategies include two forms of parallelism: (1) model parallelism and (2) data parallelism. See, e.g., Jeffrey Dean et al., “Large Scale Distributed Deep Networks,” in NIPS (2012) (hereinafter, “Dean”) (discussing parallelism in DL models) (the entire contents of which are hereby incorporated by reference herein).

In model parallelism, the DL model is split among the cluster of GPUs (e.g., each layer in the neural network may be assigned to a different GPU), and the same data is used for each part of the split model. Model parallelism is seldom required, as modern computing resources should probably be able to handle large model instances within a single machine. See, e.g., Hao Li, Asim Kadav, Krik Kruus, Cristian Ungureanu, “MALT: Distributed Data-Parallelism for Existing ML Applications,” in EuroSys'15 (2015) (hereinafter, “Hao”) (the entire contents of which are hereby incorporated by reference herein).

Data parallelism is more prominent. In data parallelism, a set of worker nodes (e.g., a GPU cluster) trains model replicas on partitions of the input data in parallel (e.g., each worker node runs a complete copy of the model, but only operates on a portion of the complete data set). As each worker node sees a different partition, it will compute gradients different from the other workers. See e.g., Pijika Watcharapichat, “Ako: Decentralized Deep Learning with Partial Gradient Exchange,” in SoCC'16 (2016) (hereinafter, “Pijika”) (discussing data parallelism) (the entire contents of which are hereby incorporated by reference herein). The set of nodes then work to achieve model convergence on the entire data set.

There are several paradigms used in data parallelism to achieve model convergence, the two primary examples being Parameter Servers (PS) and peer-to-peer (P2P). FIG. 2 illustrates an example of each of these data parallelism model paradigms. The first is a Parameter Server (PS) model 201, and the second is a peer-to-peer (P2P) model 202. Note that in FIG. 2, θ denotes the entire network's weight parameters (i.e. the different layers' weight matrices).

In the PS model 201, worker nodes 205a synchronize gradients ∇θᵢ via a parameter server 210. See, e.g., Dean. The parameter server 210 applies the gradients to the overall model and distributes updated model replicas to the worker nodes. It is possible to have multiple parallel parameter servers, each responsible only for a distinct sub-part of the model.

In the P2P model 202, worker nodes 205b exchange gradients ∇θᵢ in a direct peer-to-peer fashion. See, e.g. Hao (discussing P2P models). Here, each worker 205b node may aggregate other worker nodes' gradients with its own and may update its local model replica.

Other paradigms exist, such as a hybrid communication scheme that can choose among P2P and PS based synchronization, depending on the type of NN layer whose gradients are to be exchanged. See, e.g., Zhang.

Another consideration for distributed DL is the level of synchronicity among the worker nodes. See, e.g., Pijika. For example in some DL models, is not necessary to completely synchronize and update the worker nodes' gradients. A certain amount of staleness is permissible while still guaranteeing model convergence.

Moreover, in some distributed DL models, gradient matrix updates may be exchanged in a compressed manner, such as by Sufficient Factor Broadcasting (SFB). See, e.g., Pengtao Xie, “Distributed Machine Learning via Sufficient Factor Broadcasting,” arXiv 1409.5705v2 (2015) (discussing SFB) (the entire contents of which are hereby incorporated by reference herein). In SFB, the gradient update matrix pertaining to a single training example is rank 1. This can be decomposed into two vectors (the SFBs). This compresses a N×M matrix into two vectors u and v (of size N and M) (at the cost of decomposing and reconstructing the Matrix at sender and receiver side): ΔWi=u v^{T}. For certain NN layer types, compressed gradient matrix updates (e.g., via SFB) can be helpful where data center bandwidth is an issue.

The continued usefulness of compression and incomplete synchronization in state of the art distributed DL models illustrates that, despite the efforts and advances in NN for distributed DL, it is still easily possible to saturate a datacenter (or cluster bandwidth), which results in undesirable throttling of GPU computing resources for training. For more information on scaling learning to deep learning and big data, see also Xue-Wen Chen and Xiaotong Lin, “Big Data Deep Learning: Challenges and Perspectives,” in IEEE Access (2014) (the entire contents of which are hereby incorporated by reference herein).

Additional background information can be found in the following (the entirety of each of which is hereby incorporated by references herein: Yarin Gal and Zoubin Ghahramant, “Dropout as a Bayesian Approximation: Representing Model Uncertainty in Deep Learning,” ArXiv:1506.02142v6 (2016).

### SUMMARY

An embodiment of the present invention provides a method for synchronizing data parallel deep learning nodes that includes: training, by a deep learning node of the data parallel deep learning nodes, a deep learning model, having a hierarchy of layers, using backpropagation; interleaving, by the deep learning node, layer-wise backpropagation calculations with backpropagation message communications; assigning, by the deep learning node, priority levels to the backpropagation message communications based on the hierarchy of layers; and prioritizing, by the deep learning node, transmission among the backpropagation message communications based on the priority levels. At least one of the backpropagation message communications transmits a message having information on at least one of a gradient or a weight.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates feed forward and backpropagation passing in a neural network;

FIG. 2 illustrates example data parallelism model paradigms for neural networks;

FIG. 3 illustrates an idealized deep learning node;

FIG. 4 illustrates the increased usage of Message-Passing Interface in deep learning frameworks;

FIG. 5 illustrates the working principle of MPI_allreduce;

FIG. 6 illustrates a high level deep learning node with DLNC component according to an embodiment;

FIG. 7 illustrates application driven scheduling according to an embodiment;

FIG. 8 illustrates an embodiment of a DLNC component according to the invention;

FIG. 9 illustrates a deployment of multiple deep learning workers according to an embodiment of the invention;

FIGS. 10a-10c illustrates pseudocode according to an embodiment of the present invention;

FIG. 11 illustrates an deep image classification neural network;

FIG. 12 illustrates a comparison of different communication/computation approaches; and

FIG. 13 illustrates a block diagram of a processing system according to an embodiment.

### DETAILED DESCRIPTION

Embodiments of the present invention are directed to improving data parallel deep learning using backpropagation (e.g., in data centers and computing clusters). Embodiments of the present invention reduce waiting time for distributed deep learning with backpropagation when a communication phase duration exceeds a computation phase duration. According to embodiments, the communication phase overlaps with the computation phase and starts immediately after a particular layer becomes available. Furthermore, the communication phase is fine granular in order to carry over the different layer's computation priority into the dedicated communication phase.

An embodiment of the present invention provides a method for synchronizing data parallel deep learning nodes that includes: training, by a deep learning node of the data parallel deep learning nodes, a deep learning model, having a hierarchy of layers, using backpropagation; interleaving, by the deep learning node, layer-wise backpropagation calculations with backpropagation message communications; assigning, by the deep learning node, priority levels to the backpropagation message communications based on the hierarchy of layers; and prioritizing, by the deep learning node, transmission among the backpropagation message communications based on the priority levels. At least one of the backpropagation message communications transmits a message having information on at least one of a gradient or a weight.

In an embodiment, the layer-wise backpropagation calculations may generate prediction error data for each layer of the hierarchy of layers, the backpropagation message communications may transmit backpropagation messages, each of the backpropagation messages having information corresponding to the prediction error data for a corresponding one of the layers. The assigning priority levels operation may include, assigning one of the priority levels to each of the backpropagation messages individually based on which one of the layers corresponds to the information contained in each of the backpropagation messages.

The method may further include chunking, by the deep learning node, the backpropagation messages based on the corresponding one of the layers of the prediction error data associated with each of the backpropagation messages to create message chunks. The assigning priority levels operation may include, assigning one of the priority levels to each of the message chunks based on the corresponding one of the priority levels assigned to the corresponding one of the backpropagation messages, and the prioritizing transmission operation may include preferentially transmitting, by the deep learning node, a higher priority message chunk after the higher priority message chunk becomes available. The higher priority message chunk is one of the message chunks having a priority level that is higher than the priority levels of other ones of the available message chunks.

The chunking operation may include adapting sizes of the message chunks to optimize the prioritized transmission of the message chunks having higher priority based on data types, size of matrices, and/or dimensions of matrices of the prediction error data and/or an ability of a network used by the deep learning node to interrupt or pause ongoing transmissions.

In an embodiment, the method further includes: instantiating, by the deep learning node, network communicators corresponding to the priority levels; splitting, by the deep learning node, the backpropagation messages into message chunks as the backpropagation messages become available; and transmitting, by the deep learning node, the message chunks via a corresponding one of the network communicators. Each of the message chunks may individually correspond to a particular one of the network communicators according to a shared one of the priority levels.

In an embodiment, the prioritizing transmission operation includes executing at least one of: logic that supports TCP/IP and allocates bandwidth according to the priority levels associated with the hierarchy of layers; logic that supports MPI that instantiates multiple MPI trees according to the priority levels associated with the hierarchy of layers; and logic that supports MPI extended with a priority mechanism to assign the priority levels to the backpropagation message communications based on the hierarchy of layers.

The priority levels can be assigned such that a lower layer of the layers has a higher priority level than a higher layer of the layers.

In an embodiment, the method further includes: receiving, by a deep learning node, external backpropagation messages from other deep learning nodes of the deep learning nodes, each of the external backpropagation messages including prediction error information corresponding to a particular one of the layers of the deep learning model; and prioritizing, by the deep learning node, aggregation calculations of the prediction error information for the layers based on the hierarchy of layers.

According to another embodiment of the present invention, a deep learning node for a network of data parallel deep learning nodes is provided. The deep learning node includes: a deep learning model having a hierarchy of layers and which is trainable using a backpropagation protocol, which generates backpropagation messages for synchronizing with other ones of the deep learning nodes, the backpropagation messages being individually associated with a particular one of the layers; and a deep learning networking component that is configured to process communication of the backpropagation messages associated with lower layers of the hierarchy of layers in favor of the backpropagation messages associated with higher layers of the hierarchy of layers. The backpropagation messages include information on at least one of a gradient or a weight.

In an embodiment, the deep learning networking component is configured to partition the individual backpropagation messages into chunks.

In an embodiment, the deep learning networking component is configured to: receive external backpropagation messages from other deep learning nodes; and preferentially aggregate the external backpropagation messages associated with the lower layers of the hierarchy of layers in favor of the external backpropagation messages associated with the higher layers.

In an embodiment, at least one of the external backpropagation messages is received as a plurality of chunks.

According to another embodiment of the present invention, a non-transitory processor readable storage medium is provided that contains instructions, which when executed, cause a processor to perform the following operations: training a deep learning model using backpropagation, the deep learning model having a hierarchy of layers and configured to be instantiated in a deep learning node in a system of data parallel deep learning nodes; interleaving layer-wise backpropagation calculations with backpropagation message communications; assigning priority levels to the backpropagation message communications based on the hierarchy of layers; and prioritizing transmission among the backpropagation message communications based on the priority levels. At least one of the backpropagation message communications transmits a message including information on at least one of a gradient or a weight.

According to an embodiment, the backpropagation message communications may be configured to transmit backpropagation messages, each of the backpropagation messages including information corresponding to a prediction error data for a corresponding one of the layers. The instructions, which when executed, may further cause the process to perform the following operations: chunking the backpropagation messages based on the corresponding one of the layers of the prediction error data associated with each of the backpropagation messages to create message chunks. The priority levels can be assigned such that a lower layer of the layers has a higher priority level than a higher layer of the layers.

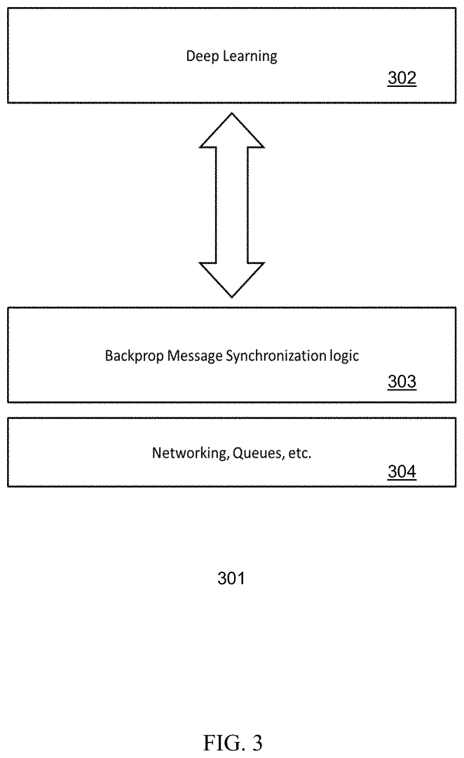

Based on the data parallelism paradigms discussed above, the inventors have determined an idealized node 301, as illustrated in FIG. 3. A Deep Learning component 302 of the idealized node 301 applies the specified deep learning model on a slice of data to which the node is assigned. This creates gradients that the node needs to synchronize according to a defined synchronization logic (e.g., PS or P2P). For example, the gradient matrix ΔW may be decomposed into sufficient factor vectors u,v. The gradients are distributed to other nodes (e.g., worker nodes) via common networking routines 304 and other workers' gradients are received. These are integrated then in the Backprop Message Synchronization Logic 303 of the idealized node 301, and fed to the Deep Learning component 302 that updates the weights accordingly. Then the node can fill the role of worker as well as Parameter Server.

As described above, when training a NN, after a forward pass through the NN layers, gradient information becomes available and can be back propagated through the NN layers (last-to-first) to adjust the weights between NN layers. See, e.g., Zhang (discussing distributed deep learning models). In distributed environments, as considered by embodiments of the present invention, the gradient information (or the adjusted weights) needs to be synchronized among working nodes (such as the idealized node 301). In the following, both the layer-wise gradient information and the layer-wise weights are denoted as backprop messages.

Note that for a forward pass, the lower layers are needed first, but the backward pass calculates these layers last. There are two conceptual approaches for the order of synchronizing.

First, after a backward pass, the backprop messages are synchronized (e.g., preferably starting with the lowest layer). The next forward pass can start as soon as the lowest layer is completely synchronized (and can continue to forward when the next layer is synchronized). The drawback of this first approach is traffic burstiness.

Second, interleaving communication of gradient update matrices with the backpropagation steps helps to reduce the traffic burstiness to some extent. As soon as gradients for a particular layer have been computed, these are sent out prior/in parallel to computing the next (lower) layer's gradients. However, that means that the lowest layer (needed for the next forward pass) is synchronized last. To continue with the next training iteration, however, the lowest layer weights information is needed first, but it becomes available last due to the way backpropagation works.

Embodiments of the present invention provide a Deep Learning-aware networking component that prioritizes traffic in a favorable way for the backpropagation training algorithm, yet still interleaves backprop messages with gradient calculations to avoid burstiness of traffic. Embodiments of the present invention allow for lower layer synchronization traffic to “overtake” higher layers. For example, in an embodiment the synchronization traffic for lower layers are preferred and processed in favor of synchronization traffic of higher layers in a concurrent situation. Embodiments of the present invention reduce the latency of starting the next forward pass (as compared to state of the art data parallel deep learning) by preferentially treating lower layer synchronization messages.

According to an embodiment of the present invention, a system for data parallel distributed deep learning is provided that: prioritizes traffic and computation for backprop message synchronization so that interleaving of communication and backpropagation is possible while also allowing lower layer communication to overtake higher layer communication; and uses chunking as partitioning gradient matrices to overcome a blocking nature of some transmission technologies to enable backprop traffic prioritization for these transmission technologies. In such system, the communication of lower layers can be processed in favor of higher layers.

An advantage of embodiments of the present invention is that their full interleaved parallel communication and computation (C&C) approach is applicable in both P2P and Parameter Server (PS) DL environments for synchronization with backpropagation training, while supporting interleaving of synchronization and gradient calculations.

Embodiments of the present invention provide NN architecture with dependent prioritization of synchronization, which is not provided in the current state of the art. See, e.g., Zongqing Lu et al., “Modeling the Resource Requirements of Convolutional Neural Networks on Mobile Devices,” in arXiv 1709.009503 (2017), and Shoahuai Shi et al., “Performance Modeling and Evaluation of Distributed Deep Learning Frameworks on GPUs,| in ArXiv 1711.05979v2 (2017) (hereinafter, “Shi”) (which survey and discuss deep learning that do not identify the approach of the present invention) (the entire contents of each of which are hereby incorporated by reference in their entirety herein). For example, the interleaving method mentioned in Zhang does not disclose prioritizing traffic dependent on the NN layer.

According to an embodiment of the present invention, a method is provided for synchronizing data parallel DL worker nodes using backpropagation that includes one or more of the following operations:
1. Interleaving on each worker, layer-wise gradient calculations with an exchange of synchronization traffic with other workers and/or parameter servers;
2. Assigning synchronization traffic priority levels based on NN architecture and instantiating a number of network communicators corresponding to priority levels;
3. As layers' backprop messages (e.g., gradients or weights) become available during the backpropagation algorithm, splitting these messages into chunks and transmitting these via the corresponding communicator for synchronization;
4. Adapting the chunk sizes to optimize the prioritized message transmission; and/or
5. In situations when multiple different layers' messages are available for transmission, preferentially treating higher priority messages' chunks as these messages become available.

The preferential treatment of higher priority message chunks may be done using, for example, a high level Distributed Learning Network Component (DLNC) that supports TCP/IP and allocates bandwidth according to the layer to be synchronized; or a high level DLNC logic that supports standard MPI (Message-Passing Interface), which assumes that one MPI communicator per NN layer is available for communication since DLNC startup.

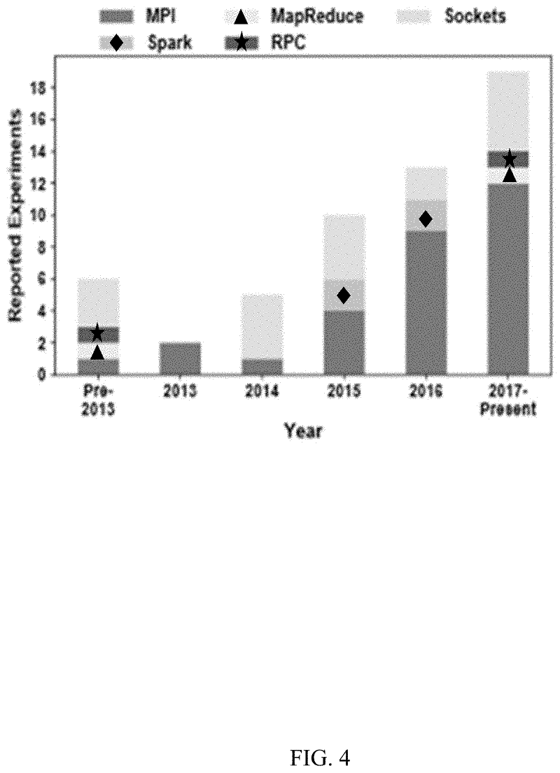

MPI is a message-passing library interface specification and is the de-facto industry standard for message-passing in high performance computing. It is a specification for a library interface, not an implementation (see available specifications at www.mpi-forum.org, the entire contents of which are hereby incorporated by reference herein). There are multiple implementations of MPI, including those that are proprietary or publicly available. FIG. 4 illustrates the increased usage of MPI in DL frameworks in the recent years. FIG. 4 is derived from a survey paper—Tal Ben-Nun, T. Hoefler, “Demystifying Parallel and Distributed Deep Learning: An In-Depth Concurrency Analysis,” arXiv 1802.09941v1 (2018) (the entire contents of which are hereby incorporated by reference herein)—and shows that MPI usage for the communication layer with distributed machine learning has been increasing.

MPI includes a wide variety of point-to-point and group communication operations. Point-to-point messages exchange data between two processes with different semantics, like synchronous, asynchronous, and buffered schemes. Other communication patterns that involve a group of processes with any cardinality are called collective operations. Collective operations provide efficient communication, such as by avoiding memory-to-memory copying, allowing overlap of computation and communication, and offloading to communication co-processors, where available. Collective operations allow the user to simplify his code and to use well tested and highly optimized routines for common collective communication patterns. Usage is simplified, well tested, and highly optimized for various patterns and the underlying hardware, hence yielding a much better performance as compared to naive implementations. The user is insulated from implementation details and MPI library implementers can optimize for specific architectures. That is, although collective operations do not provide unique functionality per se (they can be implemented manually with basic point-to-point operations), collective operations provide important advantages in programmability, safety (with regards to programming errors), and performance.

Collective operations in MPI operate over a user-specified group of processes and previously were only defined in a blocking manner. That is, a participating process waits for the collective operation to complete and the call returns, which can be as soon as the caller's participation in the collective communication is finished. Non-blocking versions of collective operations were added recently in MPI-3 and allow for explicit overlap of communication and computation—where computation is on data unrelated to collective operation.

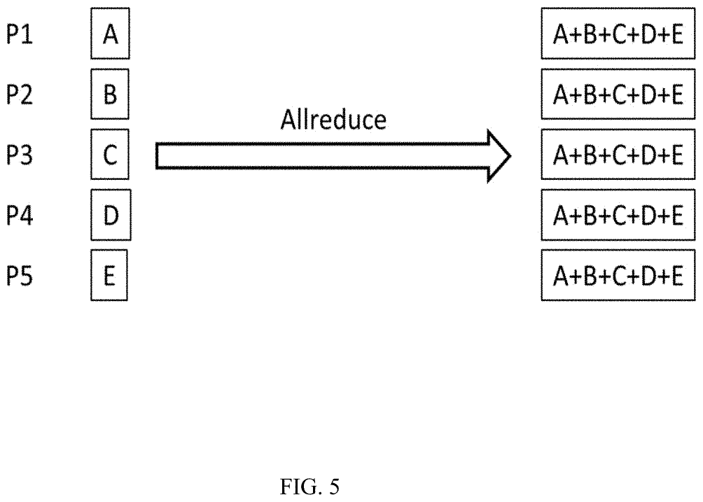

Different collective operations are available, such as: MPI Bcast (which is a one-to-all communication); MPI_Gather (which is an all-to-one communication); MPI Reduce (which is an all-to-one communication and computation with an operation like sum to combine (reduce) the data); and MPI_Allreduce (which is the respective all-to-all version). FIG. 5 illustrates the working principle of MPI_allreduce with five processes (P1-P5) and adding values (A-E). Each process holds one value. For example, process one P1 hold value A, and process two P2 holds value B. After the Allreduce operation finishes, each process holds the sum of all values of all participating processes (A+B+C+D+E).

Embodiments of the present invention have advantages over state of the art MPI systems. MPI is designed to leave the prioritization to the application logic. This means that either the application synchronizes the gradients once the backward pass is complete—which does not allow using the preferable aspects of interleaving, or the programmer sends out (preferably non-blocking) the gradients as they become available layer-per-layer. This means that, in state of the art MPI systems, lower layer traffic cannot “overtake” higher later traffic. To improve upon the state of the art, an embodiment of the present invention includes multiple MPI trees that are instantiated to implement a priority scheme.

As outlined above, and discussed below in connection with the figures, embodiments of the present invention provide a networking component that prioritizes the traffic for synchronizing NN weight matrices among multiple data parallel worker nodes—e.g., the Deep Learning Network Component (DLNC).

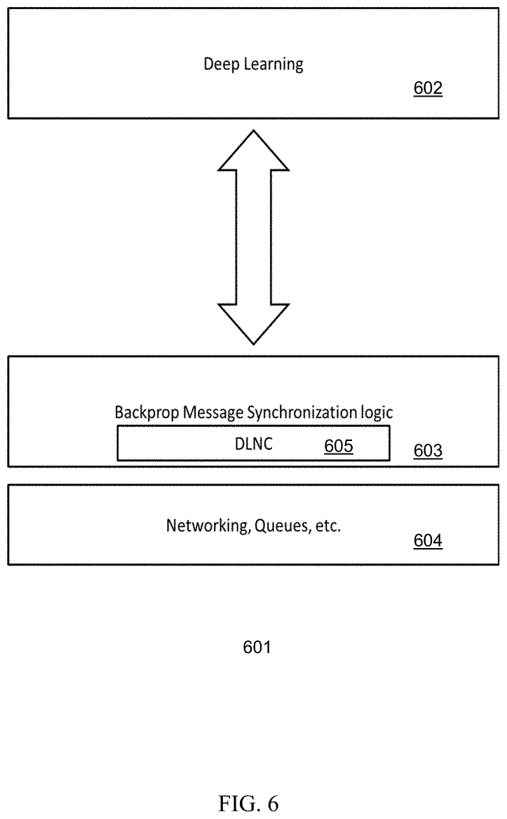

FIG. 6 shows a high level DL node 601 with DLNC 605 according to an embodiment. The high level DL node 601 includes a Deep Learning component 602 that applies a specified DL model on a slice of data to which the node is assigned. This creates gradients that the node needs to synchronize. For example, a gradient matrix ΔW may be decomposed into sufficient factor vectors u,v. The gradients are distributed to other nodes (e.g., other high level DL nodes 601) and other DL nodes' gradients are received. These gradients from other DL nodes 601 are integrated then in the Backprop Message Synchronization Logic 603 of the high level DL node 601, and fed to the Deep Learning component 602 that updates the weights accordingly. The high level DL node 601 can fill the role of worker as well as Parameter Server.

The DLNC 605 in each of the DL nodes 601 (workers or Parameter Servers) provides a link between the high-level NN framework (the NN framework can include the Deep Learning component 602 and the Backprop Message Synchronization logic 603) the programmer uses (e.g. keras, tensorflow, pytorch, etc.) and the networking functionality 604, and handles the layers' gradient synchronization traffic. After the programmer specifies the NN architecture (according to his preferences) and invokes the training process, the layer-wise traffic sizes are known. They are determined by the size of the weight matrices between the layers and the data types, here networking technology overhead may be neglected. For example, in a case of two fully connected layers, the weight matrix encoding the connections between the two layers has a number of entries (if including the bias terms) of ((# neurons layer 1+1)×(# neurons layer 2+1)). In this example, the number of entries x data type size is the matrix's size to be transmitted.

When the Backprop Message Synchronization logic 603 of the NN framework of the DL node 601 attempts to synchronize a layer's gradients as soon as a layer's gradients have been calculated in the backward pass of the backpropagation algorithm, the DLNC 605 receives not only the gradients to synchronize but also the information of the associated layer's position in the NN architecture (e.g., in the form of a layer index). For ease of exposition (but without being limiting), the example embodiments of the invention discussed herein assume that the indices are ordered increasingly with the input layer of the NN corresponding to the lowest index and the output layer of the NN corresponding to the highest index. As 0-indexed array structures and lists are common in many programming frameworks, it is a preferred embodiment to associate the lowest NN layer with the priority 0 as the highest priority. Increasing layer indexes then imply decreasing priority, down to priority to number of NN layers −1.

When the DLNC 605 has to exchange multiple layer's backprop messages that are in the process of being synchronized, it will prioritize the handling of the lowest NN layer, and consequently the associated network traffic.

In an embodiment of the present invention, the DLNC 605 will also prioritize the aggregation calculations (e.g., summation of the different workers DL nodes 601 gradient matrices) of the lowest layer to be currently synchronized. This means that the DLNC 605 will focus on aggregating the different worker DL nodes' backprop message traffic of the lowest currently available layer first.

In an embodiment of the present invention relying on one computing process (e.g., an Operating System Process, or Thread) for each layer synchronization, the DLNC 605 can rely on suitably prioritized calculation processes (i.e., higher layers have lower process priority), which delegates the handling of processes to the operating system scheduler.

In another embodiment of the present invention, the DLNC 605 aggregates the backprop messages based on the available backprop messages. The DLNC 605 may, for example, preferentially aggregate the gradients of the lowest available layers.

In distributed DL settings, a mixture of different kinds of backprop messages (e.g., gradients as well as weight matrices) are encountered. For example, in settings of worker DL nodes 601 synchronizing via one or more parameter servers, the worker DL nodes 601 send gradient update information to the parameter server, who then aggregates these and updates the layer weights. These updated weights are then distributed (e.g., synchronized to the different worker DL nodes 601). Both steps (worker DL nodes 601 sending layers' gradients to the parameter server, parameter server layer-wise aggregation calculations and application of the gradients to the respective layer weights, distributing the updated weights to all worker DL nodes 601) are covered by the DLNC 605 hosted in the DL nodes 601 operating as workers and parameter server(s), according to embodiments.

In an embodiment, the DLNC 605 receives the number of layers the respective NN encompasses when the architecture is defined (e.g., instantiated in the NN framework).

In an embodiment, the DLNC 605 uses TCP/IP for exchanging synchronization traffic. Using TCP/IP allows the DLNC 605 to instantiate a suitable number of send and receive queues associated to TCP/IP ports (e.g., one per layer). The DLNC 605 can assign network bandwidth priority to each send and receive queues based on the associated layer to implement a priority scheme.

In another embodiment, the DLNC 605 relies on the standard MPI interface specification. To control the network bandwidth allocation suitably, the DLNC 605 has to divide the backprop messages (e.g., the gradient or weight matrices) to be synchronized into smaller chunks. These smaller chunks are then distributed and aggregated by initiating a non-blocking MPI_Allreduce call. The DLNC 605 keeps track of synchronized chunks per layer. This allows the DLNC 605 to assign higher bandwidth to the lowest, currently to be synchronized, layer's gradients traffic and prioritizes lower layers' synchronization traffic, as the backpropagation progresses. This application-driven scheduling approach is possible when using MPI's non-blocking collective calls (e.g., such as MPI_IAllreduce) and a different communicator (e.g., the dedicated group of participating processes) for each layer.

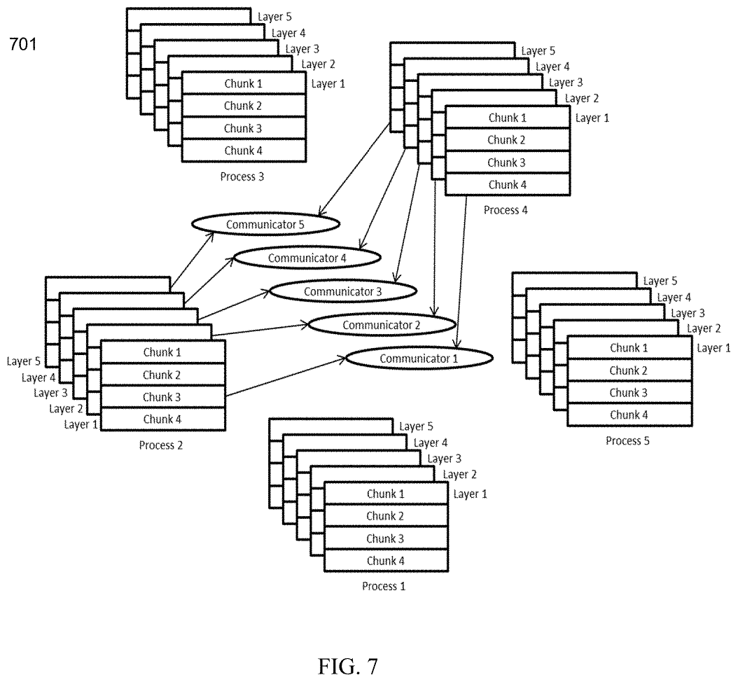

For example, FIG. 7 illustrates a NN 701 having application driven scheduling that requires one communicator per layer in order to: reduce the chunks of the same layer in-order; but the chunks of different layers out-of-order.

FIG. 7 is a logical schematic of the NN 701, which is a distributed DL system using data parallelism. The NN 701 includes multiple processes (Process 1-5), each running replicas of the DL model. The processes (Process 1-5) may be operating on a set of worker DL nodes (e.g., DL nodes 601), each process training model replicas on partitions of the input data in parallel. The DL model for NN 701 has five layers (Layer 1-5). For each of the processes (Process 1-5), the backprop messages (e.g., the gradient or weight matrices) to be synchronized are divided into chunks (Chunk 1-4) wherein each chunk is associated with a particular layer. The NN 701 also includes several communicators (Communicator 1-5), where each communicator is associated with a particular layer (Layer 1-5) of the DL model. The communicators (Communicator 1-5) may be included in each of the DL nodes of the NN 701, for example included in the DLNC of each of the DL nodes.

The NN 701 reduces the chunks of the same layer in-order, but the chunks of different layers out-of-order. For example, while Processes 1-4 each start Chunk 4 of Layer 5 with Communicator 5, Process 5 can already start Chunk 1 of Layer 4 with Communicator 4 before joining Communicator 5 with Chunk 4. In the example embodiment, the order of non-blocking calls per communicator is mandatory, but not the order of non-blocking calls of different communicators. According to an embodiment, the DLNCs of the DL nodes performs the function of reducing and distributing the chunks (Chunks 1-5).

Using different communicators allows for starting non-blocking collective calls: (a) in-order for the same layer; and (b) out-of-order for different layers: For example, referring to FIG. 7, while Process 1 continues with Chunk 4 on Layer 3, Process 2 could distribute Chunk 1 on Layer 2 before Chunk 4 on Layer 3.

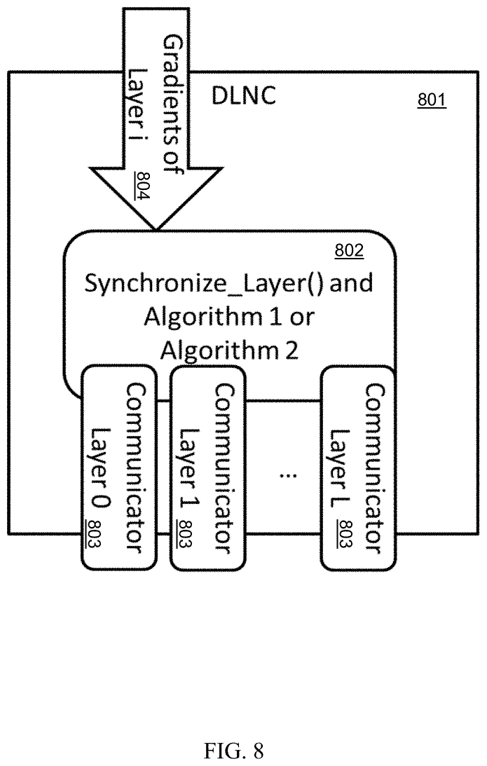

FIG. 8 depicts a DLNC 801 compatible with the architecture in FIG. 6. The DLNC 801 is suitable for MPI and TCP/IP embodiments of the present invention.

The DLNC 801 handles backprop messages 804 (e.g., gradient information) synchronization traffic. For example, as described above, after a layer's gradients have been calculated in a backward pass of the backpropagation algorithm, the DLNC 801 receives the gradients and information indicating the layer position associated with the gradients (e.g., Gradients of Layer i, as shown in FIG. 8). Also, when the DLNC 801 has to exchange multiple layer's backprop messages 804 that are in the process of being synchronized, it will prioritize the handling of the lowest NN layer, and consequently the associated network traffic.

To perform its synchronization function, the DLNC 801 may run, for example, Algorithm 1 or Algorithm 2 (discussed below), as well as the Synchronize Layer function provided by pseudocode described hereafter. In particular, the DLNC 801 may include a processing component 802 for performing a synchronization function (e.g., Algorithm 1, Algorithm 2, or Synchronize_Layer( )) on the received backprop messages 804 (e.g., Gradients of Layer i).

The DLNC 801 may also include several communicators 803. Each of the communicators may correspond to the layers of the DL model. For example, in FIG. 8, there is one communicator 803 for each of the DL model layers 0-L. The synchronization function 802 of the DLNC 801 may split the backprop messages 804 into chunks. The DLNC 801 may then transmit the chunks via the corresponding one of the communicators 803 for synchronization. Accordingly, the chunks may be created according to the associated originating layer.

In an embodiment of the present invention, a NN implements P2P synchronization such that worker DL nodes exchange gradients in a direct peer-to-peer fashion.

Recently openMPI has been integrated with Tensorflow. See, e.g., Abhinav Vishnu et al., “Distributed TensorFlow with MPI,” in arXiv:1603.02339v2 (2017) (the entire contents of which are hereby incorporated by reference herein). Embodiments of the present invention can utilize this integration to enable efficient P2P broadcasting of parameters (e.g., gradients). In particular, collective operations in MPI, such as all reduce, provide a mixture between Parameter Server and P2P approaches. Gradient Matrices for updating Layer Weights are distributed to all peers and aggregated in an optimized broadcast P2P way (in this case summed). Recently, MPI collective operations seem to be a preferred option for synchronization. The inventors have noticed that most of the mainstream DL frameworks employ MPI-Allreduce-based distributed training mechanism, such as PyTorch, MXnet, Caffe, Tensorflow, Chainer. Nvidia, which provide its highly optimized, MPI compatible, NCCL GPU collective library to achieve high bandwidth over PCIe and NVLink high-speed interconnect. These collectives are implemented using ring algorithms and have been optimized primarily for throughput.

As discussed above, non-blocking versions of collective operations were added recently in MPI-3 and allow for explicit overlap of communication and computation. Performance of many applications can be improved by overlapping communication and computation. This requires that sufficient resources are available as some collective operations (like the blocking MPI_Allreduce) include not only communication but also computation (e.g. summing up/reducing values). A non-blocking call initiates a collective operation, which must be completed in a separate completion call like MPI_Wait. Once initiated, the operation may progress independently of any computation or other communication at participating processes. As the calls return immediately, irrespective of the status of other processes, completion status can be probed with the non-blocking call MPI Test. The execution order of multiple non-blocking collective operations is implementation dependent. According to the MPI specification, the only requirement is that the function call order of multiple non-blocking collective operations of each participating process must be the same.

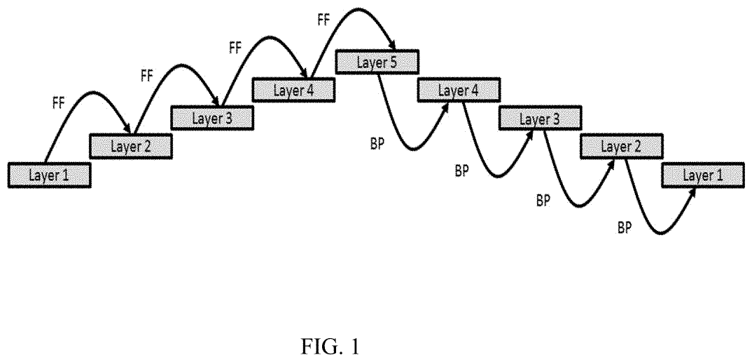

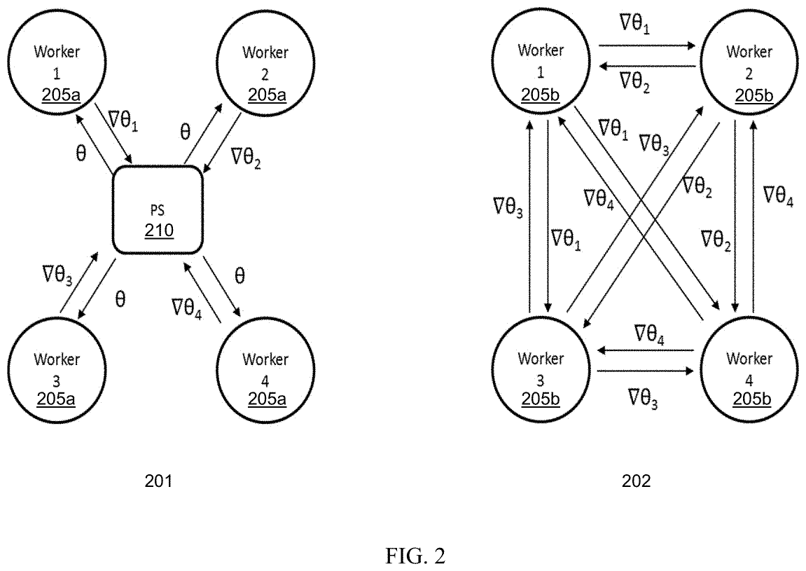

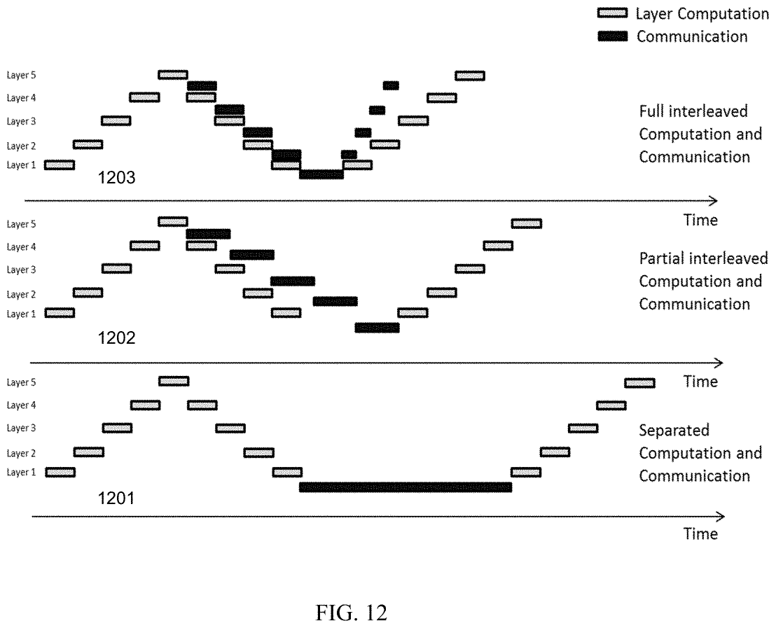

Embodiments of the present invention can utilize the non-blocking collective operation MPI_IAllreduce (the “I” hints for immediate call return as opposed to the blocking MPI_Allreduce) as it provides a sufficient communication and computation overlapping period. While one layer is computed on the backpropagation path the results of the previous, upper layer, can be reduced in the meantime (see FIG. 1 and FIG. 12).

FIG. 12 is a comparison of different communication/computation approaches in a data parallel DL system. The bottom plot (1201) shows the effect of multiple blocking collective operations. The center plot (1202) visualizes the non-blocking collective operation. The top plot (1203) indicates the performance advantage of prioritized collective operations according to embodiments of the present invention.

In each of the plots of FIG. 12, the vertical axis designates five layers (Layer 1-5) and the horizontal axis represents time. The layers (Layer 1-5) correspond to the layers in a DL model having five hierarchical layers. The numbers of the layers demonstrates their order, that is Layer 1 is the “low” layer and is an input layer that receives input data, Layers 2-4 are “intermediate” layers that are connected in sequence to the input layer and apply a function transformation, and Layer 5 is the “high” layer and is an output layer that is connected in sequence to the intermediate layers to output a prediction.

In FIG. 12, a multitude of bars are shown in each plot, each bar representing an operation. The grey bars represent a layer computation operation, and the black bars represent communication a communication operation. The position of the layer computation operation on the vertical axis indicates which of the layers (Layers 1-5) that layer computation is associated with. The horizontal position of the layer computation operations and communication operations indicates the time the operation is occurring relative to the other operations. For example, operations overlap in time of execution when their representative bars are shown at the same horizontal position. The length of the bars representing the operations indicates the relative duration of the operation.

In each of the plots of FIG. 12, a feed forward (FF) pass followed by a backpropagation (BP) pass is shown (see FIG. 1 for detail on FF and BP passes) by the layer computation operations. The layer computation operations shown in FIG. 12 also indicate a feed forward pass of a successive iteration. The communication operation corresponds to the synchronization communication among the DL nodes exchanging the backprop messages (e.g., the gradient data).

The bottom plot (1201) represents a DL system using multiple blocking collective operations. Because the collective operations are blocking, the participating processes waits for the collective operation to complete and the call returns. Thus, the synchronization communication operation among the DL nodes occurs only after each FF and BP iteration concludes. As shown in plot 1201, this results in the layer computation and communication operations being fully separated in time. This communication/computation approach results in a longer overall processing time as compared to the other approaches.

The middle plot (1202) represents a DL system using non-blocking collective operations. By using non-blocking collective operations, the DL system can have overlap of the communication and layer computation operations, as shown. This allows the DL system to interleave communications of backprop messages (e.g., gradient updates) with the backpropagation steps of the layer computation, which can improve the use efficiency of computation and network resources. As shown in plot 1202, after a BP pass, the backprop messages for the corresponding layer are synchronized with the DL nodes in the communication operation. Thus, the gradients for a particular layer can be sent out prior/in parallel to computing the next (lower) layer's gradients. By interleaving the communication and layer computation operations, the training time of a DL system can be reduced.

The top plot (1203) represents a DL system using prioritized non-blocking collective operations, according to embodiments of the present invention. Like the DL system corresponding to plot 1202, the use of non-blocking collective operations allows for interleaving of communication and layer computation operations. However, the DL system corresponding to plot 1203 additionally includes prioritization to its communication operations, prioritizing the communication of lower layer backpropagation messages over that of higher layers.

For example, as shown in plot 1203, the communication operation synchronizing the backprop messages associated with layer 5 can be interrupted in favor of a communication operation synchronizing the backprop messages associated with layer 4 as soon as that data becomes available (e.g., upon completion of the BP pass layer computation operation for layer 4). Similarly, communication operations for the backprop messages associated with layers 4-2 can be interrupted in favor communication operations for the backprop messages associated with respectively lower layers. Once the communication operation for a lower level's backprop messages is complete, the higher level layers communication operations can resume (e.g., in a successive fashion according to layer priority).

By using non-blocking operations and traffic prioritization, embodiments of the present invention can achieve computational and network use efficiency gains as compared to DL systems without both of these features. This is shown in FIG. 12 by plot 1203 having a lower total time as compared to plots 1201 and 1202. A reason for this is because systems using prioritization and non-blocking collective operations allow for the synchronization of the lowest layers to happen sooner (as compared to other communication/computation arrangements), thus allowing the next iteration of the FF and BP passes to being sooner.

In embodiments, the layer computation operations are executed with GPUs. And, because the layer computation is executed with GPUs, the compute power of the host system can be used for the reduction part of MPI_Allreduce which, in advanced MPI libraries, benefits of an optimized overlapping communication and computation pattern (chunk-wise communication with a butterfly like algorithm and reduction). In cases where the communication period exceeds the computations period—which is to be expected with the compute power of GPUs increase faster than the communication capabilities between compute nodes in a distributed environment—an overlap of consecutive collective operations will occur. There is room for performance improvement by allowing the user to prioritize the individual results of a chain with successive collective operations. For example, the result of the first collective operation is required last while the result of the last collective operation is required first. See FIG. 12 for an expected performance gain with a full interleaved communication and computation overlap prioritized by its layer ID.

The feed forwarding and backpropagation scheme benefits from a prioritized version of a non-blocking MPI_allreduce if the communication period exceeds the computation period. For example, an exemplified call sequence could look like:
gradients5=CUDA_excecute(backpropagation,layer5, error)
gradients5synchronized=MPI_IAllreduce(gradients5, . . . , MPI_SUM, PRIO5)
gradients4=CUDA_excecute(backpropagation,layer4, gradients5)
gradients4synchronized=MPI_IAllreduce(gradients4, . . . , MPI_SUM, PRIO4)
gradients3=CUDA_excecute(backpropagation,layer3, gradients4)
gradients3synchronized=MPI_IAllreduce(gradients3, . . . , MPI_SUM, PRIO3)
gradients2=CUDA_excecute(backpropagation,layer2, gradients3)
gradients2synchronized=MPI_IAllreduce(gradients2, . . . , MPI_SUM, PRIO2)
gradients1=CUDA_excecute(backpropagation,layer1, gradients2)
gradientslsynchronized=MPI_IAllreduce(gradients1, . . . , MPI_SUM, PRIO1)
MPI_Wait(gradients1synchronized)
ApplyGradients(layer1, gradients1synchronized)
layer1_out=CUDA_excecute(feedforward,layer1, input_data)
MPI_Wait(gradients2synchronized)
ApplyGradients(layer2, gradients2synchronized)
layer2_out=CUDA_excecute(feedforward,layer2, layer1_out)
MPI_Wait(gradients3synchronized)
ApplyGradients(layer, gradients3synchronized)
layer3_out=CUDA_excecute(feedforward,layer3, layer 2_out)
MPI_Wait(gradients4synchronized)
ApplyGradients(layer4, gradients4synchronized)
layer4_out=CUDA_excecute(feedforward,layer4, layer3_out)
MPI_Wait(gradients5synchronized)
ApplyGradients(layer5, gradients5synchronized)
CUDA_gradients1synchronized (feedforward,layer5, layer4_out)
layer5_out=CUDA_excecute(feedforward,layer5)

The sequence is to be seen as a part of a training iteration and assumes that a forward pass through a NN of 5 layers has been passed and that error calculations are now to be backpropagated. Layer 5 is considered the highest layer, Layer 1 the lowest (i.e. the input layer). We denote CUDA_execute the function to trigger calculations on the GPU. With “backpropagation” we denote the operation of calculating the gradients for the specified layer (e.g. “layer5”), which relies on calculating the partial derivatives with respect to the layer's weights and the layer's neurons' activation functions (and the error/gradients of the next higher layer). With “feed forward” we denote the operation of applying the layer's weights and activations to the input to the layer (input batch/or preceding layer's activation output). The MPI_IAllreduce denotes the non-blocking function call to the MPI networking stack to exchange and aggregate the gradients among the DL nodes. MPI_SUM denotes that a summing operation is to be applied by all the DL nodes to the gradients received from the other nodes (and their own). This sequence assumes that priority levels can be provided to the MPI operations, e.g. “PRIO5”. MPI_Wait( ) is a function that waits for finishing the MPI aggregation of an indicated variable, e.g. gradients1synchronized. ApplyGradients( ) will apply the indicated gradients to the respective layer's weights based on the learning rate usual in the deep learning backpropagation setting described above. In short, the above sequence calculates on the GPU a backpropagation pass through the NN's 5 layers starting with an error due to a non-illustrated forward pass, synchronizes the layers' gradients with the other DL nodes, and calculates a new forward pass on another input data batch—after which another of this sequence would be applied.

In an embodiment of the present invention, MPI is extended with a prioritization mechanism avoiding the need for a DLNC to initiate one non-blocking MPI_IAllreduce call per layer. This is the library-driven scheduling approach. The DLNC uses this MPI prioritization mechanism such that the lower NN layers receive higher priority for the synchronization traffic and the associated collective aggregation operations.

In embodiment, using multiple MPI broadcast trees or multiple TCP/IP queues can be avoided as follows. This embodiment relies on transmitting (and if collective operations are used, also aggregating) the different layers' backprop message data in small chunks of configurable size (for example determined by an administrator in dependence of the networking technology). In this embodiment, additional book-keeping information is transmitted among the workers and/or the Parameter Server to identify the layer the synchronization traffic chunk refers to.

In an embodiment where TCP/IP (or another transport protocol) is used, the DLNC will assign high bandwidth to the gradients of the layer with the lowest index by means of handling the synchronization data in the corresponding send/receive queues preferentially. This allows the DLNC to assign higher bandwidth to the lowest currently to be synchronized layer's backprop message traffic which results in a suitable traffic prioritization. For this, the DLNC continuously monitors the send and receive queues.

In embodiments where the networking technology (e.g., Infiniband) does not support interrupting or pausing ongoing transmissions (e.g., a large gradient matrix currently being exchanged), the DLNC will exchange the backprop messages in smaller chunks. This allows the DLNC to flexibly react to lower layer messages becoming available even for these networking technologies.

As the backpropagation algorithm's backward pass makes available the gradients of lower layers one after the other, the DLNC re-prioritizes the non-completed synchronization traffic and the associated operations.

In embodiments using chunking to transmit backprop messages, the DLNC is either preconfigured or it relies on a deterministic algorithm that finds, depending on the different layers' weight matrices' dimensions, the data types, and the networking technology used a suitable chunking size for network transmission. If the networking technology maximum transmission unit is known to the DLNC, this may be used to determine the chunk size. For example, chunk size=floor(MTU/data type size) where we denote with floor the rounding down of the division.

Embodiments of the present invention provide strict synchronization of backprop messages in a data parallel setting. Embodiments can be extended to relaxed synchronization settings by accounting for the allowable slack times and tracking and transmitting the different worker's training epoch progress. This relaxation can be achieved by not waiting for all worker's gradients to be synchronized, e.g. by modifying the MPI_WAIT functionality in the call sequence discussed above. This modification would cancel the waiting for the completion of workers' full gradient synchronization after exceeding a configurable maximum waiting time. Thus, not fully synchronized gradients will be used in the next feed-forward calculations (and thus affects the next error backpropagation calculations). In that case it may be beneficial to, e.g., enforce full synchronization of gradient updates after a configurable number of training iterations or after processing a configurable number of mini batches of input data.

According to embodiments of the present invention, the DLNC component can be implemented in software. A software-implemented DLNC component allows direct integration into deep learning libraries and frameworks.

According to embodiments of the present invention, the DLNC component can be hosted in deep packet inspection nodes inside the network to prioritize synchronization traffic suitably depending on the network structure.

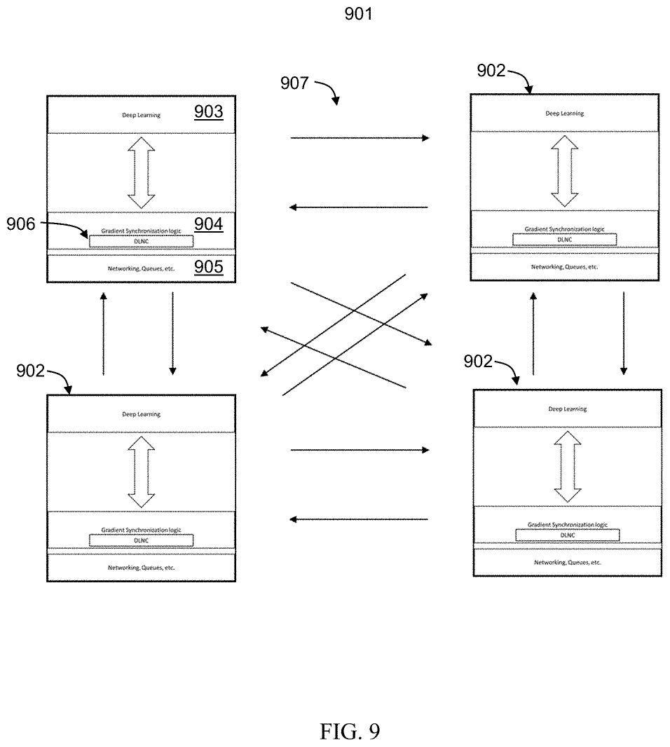

FIG. 9 depicts a NN 901 that includes a deployment of multiple DL workers 902 (e.g., using MPI) that synchronize the backprop messages 907 using a DLNC 906. The embodiment of FIG. 9 illustrates four DL workers 902, but the invention is not so limited. FIG. 9 depicts P2P full gradient updates in the NN 901 of DL workers with DLNC 906, assuming gradients as backprop messages 907. The DL workers 902 may be implemented by DL nodes (e.g., DL nodes 605) operating as workers, each DL worker 902 including a Deep Learning component 903, a Gradient Synchronization logic component 904, and a Networking component 904 (these components may be implemented similarly to the Deep learning component 602, Backprop Synchronization logic component 603, and network functionality 604 discussed above). Each DL worker also includes a DLNC 605 (e.g., implemented similarly to the DLNC components 605 and 801 discussed above) operatively included with its Gradient Synchronization logic component 904.

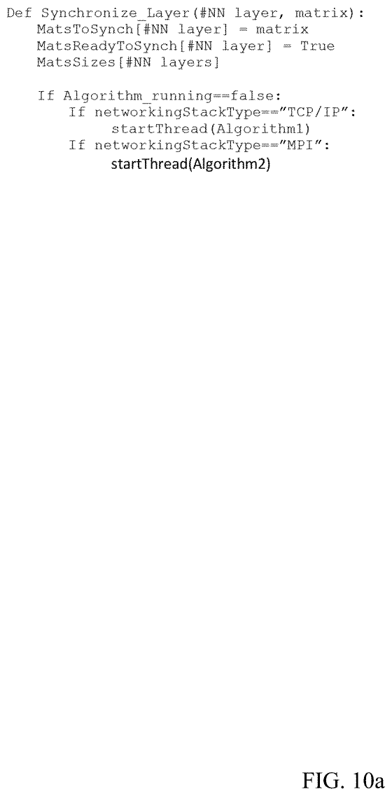

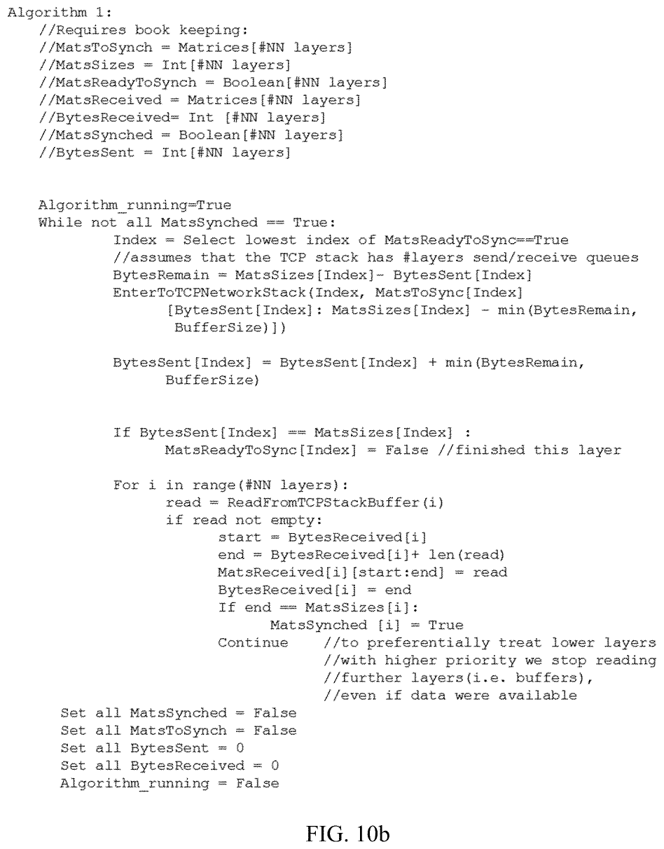

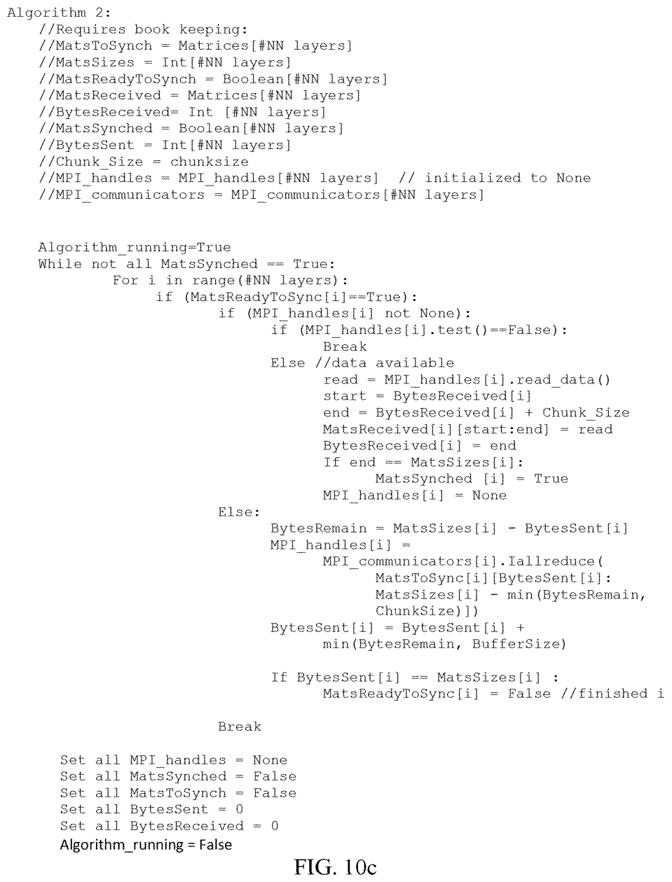

FIGS. 10a-10c show pseudocode according to an embodiment of the present invention. The pseudocode assumes that no synchronization/memory access problems of multi-threaded access within a DLNC exist (embodiments of the present invention are not limited by this assumption). The functionality of the pseudocode may be implemented by an embodiment of a DLNC (e.g., DLNC 605, 801, or 906) according to the invention. For example DLNC 801 may execute the pseudocode using its processing component 802.

FIG. 10a defines Function Synchronize_Layer, which is called whenever the high level NN framework attempts to synchronize the backprop messages of a layer. As shown, the Synchronize_Layer function takes a layer number identifier (# NN layer) and a layer's matric (matrix) as inputs. The Synchronize_Layer function enters the respective layer's (weight or gradient) matrix into the DLNC synchronization. In each training epoch (e.g., a backward pass), the first call to Synchronize_Layer starts a thread running an algorithm for synchronizing the gradients via the network without stopping. The algorithm will implement the DLNC application driven scheduling option. It will prioritize lower layers and will assume that the deep learning library will have access to the received matrices and the book keeping array MatsSynched that keeps track of completed layers' matrices.

The Synchronize_Layer function may start a particular subthread of the algorithm based upon whether the networking stack being used is a TCP/IP type or an MPI type. As shown in FIG. 10a, when the Synchronize_Layer function determines that the networking stack type is TCP/IP in starts a thread for the subalgorithm Algorithm 1; and when the network stack type is MPI, it starts a thread for the subalgorithm Algorithm 2. According to an embodiment, each of Algorithm 1 and Algorithm 2 implements the DLNC application driven scheduling option, prioritizing lower layers.

FIG. 10b shows Algorithm 1, which is a high level DLNC logic that supports TCP/IP and allocates bandwidth according to the layer to be synchronized. It is suitable for networks with parameter servers as the received matrices are not aggregated further with other incoming matrices (of the same layer).

Algorithm 1 works by looping over all layer's weight matrices and maintaining logical indicators of which matrices have been sent out to other DL nodes already and for which matrices already bytes have been received.

The algorithm assumes that it is possible to identify a layer to the networking stack, e.g. by TCP port numbers. The algorithm keeps track of the bytes already sent for each matrix and has access to the matrices' sizes. It will then select the lowest layer's weight matrix that has not been synchronized completely, yet, to continue synchronizing with the other DL nodes. It does so by sending a number of bytes (depending on the chunk_size) parameter to the other DL nodes. It then checks for all layers whether traffic has been received (ReadFromTCPStackBuffer(i)) and adds the received bytes to the corresponding matrix—this is to be repeated for all DL nodes in the network. While not all matrices have been sent out and received from the other DL nodes, the loop continues. Algorithm 1 is not strictly limited to the above example, that is variations and optimizations of Algorithm 1 are within the scope of the invention as a person of ordinary skill would recognize.

FIG. 10c shows Algorithm 2, which is a high level DLNC logic that supports standard MPI. Algorithm 2 assumes that one MPI communicators per NN layer is available for communication since DLNC start-up. This is realized by relying on non-blocking MPI Iall_reduce and the ability of testing the corresponding MPI transmission handles returning “True” when Iall_reduce is complete (and “False” when MPI still is performing the collective operation). The algorithm loops over all layers from lowest to highest and checks if data is available from the MPI networking stack.

If a layer's matrix is not yet completely synchronized, and an MPI handle exists (i.e., it is not of type None)—which indicates that in a prior iteration of Algorithm 2 a chunk of this layer's matrix was sent to be synchronized, and the handle indicates that data is available for reading, the algorithm reads the synchronized data into the respective layer's matrix. By setting the corresponding MPI handle to “None” after reading it keeps track of the chunk synchronizations status of different matrices. If the last remaining bytes of the layer's matrix have been received, i.e. if end==MatsSizes[i], the matrix is marked as completely synchronized.

If a layer's MPI handle is None, the algorithm sends the next chunk of the layer's matrix′ bytes for synchronization via the non-blocking MPI_IAllreduce and memorizes the returned handle. If all bytes have been sent out, the matrix is marked as completely sent.

After reading or sending out a chunk, Algorithm 2 exists the for loop and re-enters the while loop. This way, it starts again iterating over the different layers from lowest to highest—and this way, the beneficial prioritization of lower layers is realized by Algorithm 2. As a person of ordinary skill in the art would readily appreciate, variations and optimizations of Algorithm 2 are within the scope of the present invention.

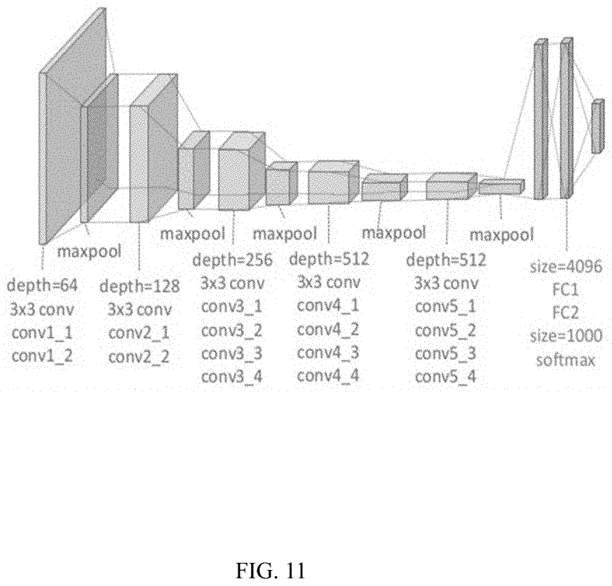

To illustrate some of the benefits of the present invention, it is instructive to discuss the invention in conjunction with deep Image Classification NN, VGG-19. Deep Image Classification NN, VGG 19 is illustrated in FIG. 11. See also, Karen Simoyan et al., “Very Deep Convolutional Networks for Large-Scale Image Recognition,” arXiv 1409.15556v6 (2015) (the entire contents of which are hereby incorporated by reference herein).

According to the keras library (keras is a high-level neural networks API, capable of running on top of TensorFlow; see https://keras.io), the VGG-19 model has 143,667,240 trainable parameters. More specifically the layers (as specified in the keras library) shown in Table 1 with an X in the Synch column would need synchronization because the trainable parameters are subject to gradient calculations in the backward pass.

TABLE 1

| Layer (type) | Output Shape | Param # | Sync |
|---|---|---|---|
| input_1 (InputLayer) | (None, 3, 224, 224) | 0 | |
| block1_conv1 | (None, 64, 224, 224) | 1792 | X |
| (Conv2D) | | | |
| block1_conv2 | (None, 64, 224, 224) | 36928 | X |
| (Conv2D) | | | |
| block1_pool | (None, 64, 112, 112) | 0 | |
| (MaxPooling2D) | | | |
| block2_conv1 | (None, 128, 112, 112) | 73856 | X |
| (Conv2D) | | | |
| block2_conv2 | (None, 128, 112, 112) | 147584 | X |
| (Conv2D) | | | |
| block2_pool | (None, 128, 56, 56) | 0 | |
| (MaxPooling2D) | | | |
| block3_conv1 | (None, 256, 56, 56) | 295168 | X |
| (Conv2D) | | | |
| block3_conv2 | (None, 256, 56, 56) | 590080 | X |
| (Conv2D) | | | |
| block3_conv3 | (None, 256, 56, 56) | 590080 | X |
| (Conv2D) | | | |
| block3_conv4 | (None, 256, 56, 56) | 590080 | X |
| (Conv2D) | | | |
| block3_pool | (None, 256, 28, 28) | 0 | |
| (MaxPooling2D) | | | |
| block4_conv1 | (None, 512, 28, 28) | 1180160 | X |
| (Conv2D) | | | |
| block4_conv2 | (None, 512, 28, 28) | 2359808 | X |
| (Conv2D) | | | |
| block4_conv3 | (None, 512, 28, 28) | 2359808 | X |
| (Conv2D) | | | |
| block4_conv4 | (None, 512, 28, 28) | 2359808 | X |
| (Conv2D) | | | |
| block4_pool | (None, 512, 14, 14) | 0 | |
| (MaxPooling2D) | | | |
| block5_conv1 | (None, 512, 14, 14) | 2359808 | X |
| (Conv2D) | | | |
| block5_conv2 | (None, 512, 14, 14) | 2359808 | X |
| (Conv2D) | | | |
| block5_conv3 | (None, 512, 14, 14) | 2359808 | X |
| (Conv2D) | | | |
| block5_conv4 | (None, 512, 14, 14) | 2359808 | X |
| (Conv2D) | | | |
| block5_pool | (None, 512, 7, 7) | 0 | |
| (MaxPooling2D) | | | |
| flatten (Flatten) | (None, 25088) | 0 | |
| fc1 (Dense) | (None, 4096) | 102764544 | X |
| fc2 (Dense) | (None, 4096) | 16781312 | X |
| predictions (Dense) | (None, 1000) | 4097000 | X |

Total params: 143,667,240
Trainable params: 143,667,240
Non-trainable params: 0

Table 2 illustrates the corresponding matrices to be exchanged per mini-batch & DLNC node, assuming 32-bit precision floating point representation and 10 Gpbs and 56 Gbps transmission without any latency, networking overhead sizes, etc. and assuming exclusive medium access.

TABLE 2

| | | Size | Time [ms] | Time [ms] |
|---|---|---|---|---|
| Layer Name | #Parameters | [MB] | @10 Gbps | @56 Gbps |
| block1_conv1 | 1792 | 0.01 | 0.0057344 | 0.001024 |
| block1_conv2 | 36928 | 0.14 | 0.1181696 | 0.021102 |
| block2_conv1 | 73856 | 0.28 | 0.2363392 | 0.042203 |
| block2_conv2 | 147584 | 0.56 | 0.4722688 | 0.084334 |
| block3_conv1 | 295168 | 1.13 | 0.9445376 | 0.168667 |
| block3_conv2 | 590080 | 2.25 | 1.888256 | 0.337189 |
| block3_conv3 | 590080 | 2.25 | 1.888256 | 0.337189 |
| block3_conv4 | 590080 | 2.25 | 1.888256 | 0.337189 |
| block4_conv1 | 1180160 | 4.5 | 3.776512 | 0.674377 |
| block4_conv2 | 2359808 | 9 | 7.5513856 | 1.348462 |
| block4_conv3 | 2359808 | 9 | 7.5513856 | 1.348462 |
| block4_conv4 | 2359808 | 9 | 7.5513856 | 1.348462 |
| block5_conv1 | 2359808 | 9 | 7.5513856 | 1.348462 |
| block5_conv2 | 2359808 | 9 | 7.5513856 | 1.348462 |
| block5_conv3 | 2359808 | 9 | 7.5513856 | 1.348462 |
| block5_conv4 | 2359808 | 9 | 7.5513856 | 1.348462 |
| fc1 | 102764544 | 392.02 | 328.8465408 | 58.7226 |
| fc2 | 16781312 | 64.02 | 53.7001984 | 9.589321 |
| predictions | 4097000 | 15.63 | 13.1104 | 2.341143 |

Table 3 illustrates benchmark measures, which are based on CNN benchmarks available at https://github.com/jcjohnson/cnn-benchmarks. The CNN benchmark measures full and backward times, as such it is not appropriate in all respects. Nevertheless, from these benchmarks, it can be seen that on the GPU variants with CUDA support (cuDNN versions indicated), the total backward pass is less than fcl transmission alone for a mini-batch size of 16.

TABLE 3

| | | Forward | Backward | Total |
|---|---|---|---|---|
| GPU | cuDNN | (ms) | (ms) | (ms) |
| Pascal Titan X | 5.1.05 | 48.09 | 99.23 | 147.32 |
| GTX 1080 Ti | 5.1.10 | 48.15 | 100.04 | 148.19 |
| Pascal Titan X | 5.0.05 | 55.75 | 134.98 | 190.73 |
| GTX 1080 | 5.1.05 | 68.95 | 141.44 | 210.39 |
| Maxwell Titan X | 5.1.05 | 73.66 | 151.48 | 225.14 |
| GTX 1080 | 5.0.05 | 79.79 | 202.02 | 281.81 |
| Maxwell Titan X | 5.0.05 | 93.47 | 229.34 | 322.81 |
| Maxwell Titan X | 4.0.07 | 139.01 | 279.21 | 418.22 |
| Pascal Titan X | None | 121.69 | 318.39 | 440.08 |
| GTX 1080 | None | 176.36 | 453.22 | 629.57 |
| Maxwell Titan X | None | 215.92 | 491.21 | 707.13 |
| CPU: Dual Xeon E5-2630 v3 | None | 3609.78 | 6239.45 | 9849.23 |

Considering, for example, the benchmark numbers for Maxwell Titan X (cuDNN: 4.0.0.7), the entire backward pass from predictions layer to block1_conv1 takes about 280 ms, meaning at least 110 ms of GPU idle time before the next forward pass can start from layer 1. Transmitting all layers of VGG-19 (except fcl) takes about 130 ms.

By using DL aware traffic prioritization, embodiments of the present invention enable overlapping of the computations and aggregations of the lower layers (e.g., below fcl) with the transmission of fcl and start computing the next forward pass already.

The value of embodiments of the present invention can be seen, for example, by considering when bandwidth is increased to Infiniband (e.g., 56 Gbps, the total communication is reduced to about 82 ms. While this total communication is smaller than the entire forward pass of the selected benchmark row, it is worth noting that in conventional data parallel communication and computation (C&C) for deep learning, the lower layers will have to wait for transmission until fcl has been transmitted. The DLNC of embodiments of the present invention allows the system to overlap the computations and aggregations of the lower layers and possibly hide the communication delay altogether. This translates into higher GPU resource use.

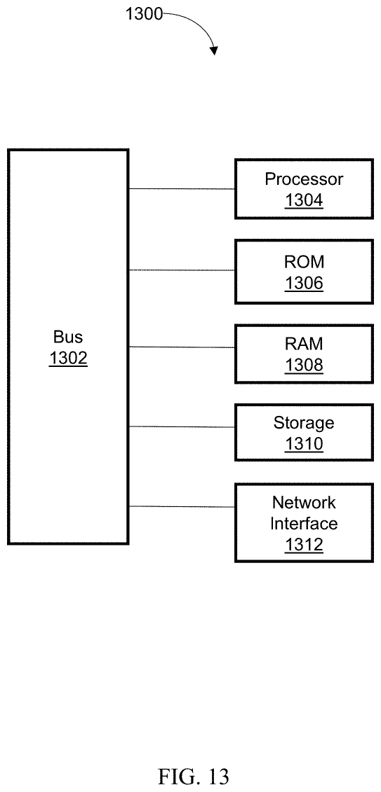

FIG. 13 is a block diagram of a processing system according to an embodiment. The processing system 1300 can be used to implement the protocols, devices, mechanism, systems and methods described above. The processing system 1300 includes a processor 1304, such as a central processing unit (CPU) of a computing device or a distributed processor system. The processor 1304 executes processor executable instructions comprising embodiments of the system for performing the functions and methods described above. In embodiments, the processor executable instructions are locally stored or remotely stored and accessed from a non-transitory computer readable medium, such as storage 1310, which may be a hard drive, cloud storage, flash drive, etc. Read Only Memory (ROM) 1306 includes processor executable instructions for initializing the processor 1304, while the random-access memory (RAM) 1308 is the main memory for loading and processing instructions executed by the processor 1304. The network interface 1312 may connect to a wired network or cellular network and to a local area network or wide area network, such as the Internet.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for synchronizing data parallel deep learning nodes, the method comprising:
training, by a deep learning node of the data parallel deep learning nodes, a deep learning model, having a hierarchy of layers, using backpropagation;
interleaving, by the deep learning node, layer-wise backpropagation calculations with backpropagation message communications;
assigning, by the deep learning node, priority levels to the backpropagation message communications based on the hierarchy of layers; and
prioritizing, by the deep learning node, transmission among the backpropagation message communications based on the priority levels,
wherein at least one of the backpropagation message communications transmits a message comprising information on at least one of a gradient or a weight.

2. The method according to claim 1,
wherein the layer-wise backpropagation calculations generate prediction error data for each layer of the hierarchy of layers,
wherein the backpropagation message communications transmit backpropagation messages, each of the backpropagation messages comprising information corresponding to the prediction error data for a corresponding one of the layers, and
wherein the assigning priority levels operation comprises, assigning one of the priority levels to each of the backpropagation messages individually based on which one of the layers corresponds to the information contained in each of the backpropagation messages.

3. The method according to claim 2, wherein the method further comprises chunking, by the deep learning node, the backpropagation messages based on the corresponding one of the layers of the prediction error data associated with each of the backpropagation messages to create message chunks, wherein
the assigning priority levels operation comprises, assigning one of the priority levels to each of the message chunks based on the corresponding one of the priority levels assigned to the corresponding one of the backpropagation messages,
the prioritizing transmission operation comprises preferentially transmitting, by the deep learning node, a higher priority message chunk after the higher priority message chunk becomes available, and
the higher priority message chunk is one of the message chunks having a priority level that is higher than the priority levels of other ones of the available message chunks.

4. The method according to claim 3, wherein the chunking operation comprises adapting sizes of the message chunks to optimize the prioritized transmission of the message chunks having higher priority based on data types, size of matrices, and/or dimensions of matrices of the prediction error data and/or an ability of a network used by the deep learning node to interrupt or pause ongoing transmissions.

5. The method according to claim 2, the method further comprising
instantiating, by the deep learning node, a plurality of network communicators corresponding to the priority levels;
splitting, by the deep learning node, the backpropagation messages into message chunks as the backpropagation messages become available; and
transmitting, by the deep learning node, the message chunks via a corresponding one of the network communicators,
wherein each of the message chunks individually corresponds to a particular one of the network communicators according to a shared one of the priority levels.

6. The method according to claim 1, wherein the prioritizing transmission operation comprises executing at least one of:
logic that supports TCP/IP and allocates bandwidth according to the priority levels associated with the hierarchy of layers;
logic that supports MPI that instantiates multiple MPI trees according to the priority levels associated with the hierarchy of layers; and
logic that supports MPI extended with a priority mechanism to assign the priority levels to the backpropagation message communications based on the hierarchy of layers.

7. The method according to claim 1, wherein the priority levels are assigned such that a lower layer of the layers has a higher priority level than a higher layer of the layers.

8. The method according to claim 1, the method further comprising:
receiving, by a deep learning node, external backpropagation messages from other deep learning nodes of the deep learning nodes, each of the external backpropagation messages comprising prediction error information corresponding to a particular one of the layers of the deep learning model; and
prioritizing, by the deep learning node, aggregation calculations of the prediction error information for the layers based on the hierarchy of layers.

9. A deep learning node for a network of data parallel deep learning nodes, the deep learning node comprising:
a deep learning model having a hierarchy of layers and which is trainable using a backpropagation protocol, which generates backpropagation messages for synchronizing with other ones of the deep learning nodes, the backpropagation messages being individually associated with a particular one of the layers; and
a deep learning networking component that is configured to process communication of the backpropagation messages associated with lower layers of the hierarchy of layers in favor of the backpropagation messages associated with higher layers of the hierarchy of layers,
wherein the backpropagation messages comprise information on at least one of a gradient or a weight.

10. The deep learning node according to claim 9, wherein the deep learning networking component is configured to partition the individual backpropagation messages into chunks.

11. The deep learning node according to claim 9, wherein the deep learning networking component is configured to:
receive external backpropagation messages from other deep learning nodes; and
preferentially aggregate the external backpropagation messages associated with the lower layers of the hierarchy of layers in favor of the external backpropagation messages associated with the higher layers.

12. The deep learning node according to claim 11, wherein at least one of the external backpropagation messages is received as a plurality of chunks.

13. A non-transitory processor readable storage medium comprising instructions, which when executed, cause a processor to perform the following operations:
training a deep learning model using backpropagation, the deep learning model having a hierarchy of layers and configured to be instantiated in a deep learning node in a system of data parallel deep learning nodes;
interleaving layer-wise backpropagation calculations with backpropagation message communications;
assigning priority levels to the backpropagation message communications based on the hierarchy of layers; and
prioritizing transmission among the backpropagation message communications based on the priority levels,
wherein at least one of the backpropagation message communications transmits a message comprising information on at least one of a gradient or a weight.

14. The non-transitory processor readable storage medium according to claim 13,
wherein the backpropagation message communications are configured to transmit backpropagation messages, each of the backpropagation messages comprising information corresponding to a prediction error data for a corresponding one of the layers, and
wherein the instructions, which when executed, further cause the process to perform the following operations:
chunking the backpropagation messages based on the corresponding one of the layers of the prediction error data associated with each of the backpropagation messages to create message chunks.

15. The non-transitory processor readable storage medium according to claim 13,
wherein the priority levels are assigned such that a lower layer of the layers has a higher priority level than a higher layer of the layers.
